(19) United States
(12) Patent Application Publication
(10) Pub. No.: US 2006/0228275 A1
(43) Pub. Date: Oct. 12, 2006

(54) Unit for filtering and treatment of organic compounds, method for production thereof and air-conditioning unit provided with such a unit

(76) Inventors: Emmanuel Rutman, Serrieres En Chautagne (FR); Philippe Petit, Ruffieux (FR); Roland Clavel, Le Vivier Du Lac (FR); Christian Bois, Beon (FR)

Correspondence Address: Ralph A Dowell;Dowell & Dowell, 2111 Eisenhower Avenue, Suite 406, Alexandria, VA, 22314, US

(21) Appl. No.: 10/548,177

(22) PCT Filed: Mar. 9, 2004
(86) PCT No.: PCT/FR04/00559

§ 371 Date: Jun. 5, 2006

(30) Foreign Application Priority Data
Mar. 10, 2003 (FR) 0302934

(51) Int. Cl. B01J 19/12

(52) U.S. Cl. 422/186.3

(57) ABSTRACT

The invention relates to a unit (20), for filtering and treatment of organic compounds, for an air-conditioning unit, comprising at least one filtration medium (203, 204) with an adsorption agent (242), such as activated charcoal and a photocatalytic agent (243), such as TiO₂. The filtration medium (203, 204) is divided amongst two filtration modules (201, 202) for successive passage of the air flow (F₃) for filtration and treatment, whilst a module (205) for irradiation of the photocatalytic agent (243) is arranged between the filtration modules (201, 202) and is also for passage of the air flow (F₃).

The invention relates to an assembly for filtering air and treating organic compounds, to a method for the production of such an assembly and to an air-conditioning apparatus, especially for buildings, which is equipped with such an assembly.

It is known to equip an air-conditioning machine with an activated carbon filter which enables the organic molecules present in the atmosphere to be adsorbed, especially during pollution peaks. Adsorption with activated carbon is currently one of the most efficient techniques for treating organic vapours present in gaseous industrial effluents. The disadvantage of that type of filter is the relatively rapid saturation of the filtration medium corresponding to the breakthrough point of the carbon.

In order to improve the filtering power of certain media, consideration has been given, as in FR-A-2 812 825, to the association, in the same filtration medium, of a photocatalytic agent and activated carbon which are affixed in the form of two layers covering a permeable support. Such a filtration medium has not hitherto been used for an air-conditioning apparatus.

It is also known from EP-A-0 798 143 to use, in the field of motor vehicles, a photocatalysis filter for trapping mainly compounds of the NOₓ type in order to treat odours, especially tobacco odours, which are found in vehicles. These photocatalysis filters can be associated with separate adsorption filters which are intended to remove neutral gases containing aromatic compounds. When a photocatalysis filter is used, it is not provided that this filter should contain activated carbon. In addition, the filtration device thus created must be installed piece by piece in a passage for the purification of air and is in practice compatible only with low rates of airflow, such as may be encountered in the treatment of the interior space of a motor vehicle. Finally, the lamp used must be put in place in a duct in which the filters are accommodated, which is a lengthy and tedious process.

It is those disadvantages which the invention is more particularly intended to remedy by proposing an assembly for filtering and treating organic compounds for an air-conditioning apparatus which can be used in the field of buildings, the construction of which assembly is easy and compatible with air passage rates of from 0 to 3 metres per second (m/s), or even more.

To that end, the invention relates to an assembly for filtering and treating organic compounds for an air-conditioning apparatus, comprising at least one filtration medium, wherein:
the filtration medium comprises an adsorption agent and a photocatalytic agent;
the filtration medium is distributed in two filtration modules through which the stream of air to be filtered and treated is to pass in succession and
illumination means for the photocatalytic agent are interposed between the filtration modules,
   characterized in that the illumination means are located in a module through which the stream passes and which constitutes, with the filtration modules, the filtration assembly.

In accordance with the present invention, an air-conditioning apparatus is an apparatus which comprises at least one unit for treating air in order to vary one of the physical properties thereof. Such an apparatus may be a power plant, a fan convector, a climate-control device, a control cabinet for a computer room, etc . . . .

By means of the invention, the construction of the filtration and treatment assembly in the form of three modules through which the stream of air is to pass in succession enables its production to be optimized by adapting its transverse dimensions and the properties of its different modules to the apparatus with which it is to be associated as well as to the type of air to be treated and filtered. This assembly formed by three modules constitutes, in an advantageous but optional manner, a unitary device which can be readily prefabricated and stored with a view to its integration in the air-conditioning apparatus.

According to advantageous aspects, an assembly for filtering and treating air may incorporate one or more of the following features:
The adsorption agent and the photocatalytic agent are distributed, respectively, over one or, respectively, both sides of a permeable support. In that case, it may be provided that the adsorption agent is distributed over the upstream side of the filtration medium located in the upstream filtration module and over the downstream side of the filtration medium located in the downstream filtration module, while the photocatalytic agent is distributed over the downstream side of the filtration medium located in the upstream filtration module and over the upstream side of the filtration medium located in the downstream filtration module. Thus, the photocatalytic agent is oriented towards the lamps of the illumination module, which promotes its action, while the adsorption agent does not disturb the action of the radiation, especially ultra-violet radiation, which brings about the passage of some electrons of the photocatalytic agent from the valence band to the conduction band. The photocatalytic agent may be TiO₂ or any other suitable agent, while the adsorption agent may be, for example, activated carbon.
The above-mentioned modules are fitted together in a reversible manner, which enables them to be separated in order to gain access to the illumination module, in particular with a view to a maintenance operation on the lamps.
The illumination module incorporates ultra-violet lamps and optionally devices for supplying power to those lamps. The entire illumination function is thus contained in this module.
The illumination module is provided with at least one plate which separates two adjacent lamps and which is covered, on at least one of its faces, with photocatalytic agent.
The filtration medium is pleated, with a view to optimizing the filtering surface and illumination obtained, in the filtration modules, which enables its active surface to be increased without increasing the transverse dimensions of those modules.

The invention relates also to a method for the production of a filtration and treatment assembly such as described above which comprises steps consisting in:
selecting the frames of the modules as a function of the dimensions of the air-conditioning apparatus to be equipped;
selecting the filtration medium as a function of the type of particle to be treated;
selecting the type, the number and the power of the lamps of the illumination module and
interposing the illumination module between the filtration modules.

In an advantageous but optional manner it may be provided that the modules are assembled to form a unitary assembly suitable for being integrated in the above-mentioned apparatus.

Finally, the invention relates to an air-conditioning apparatus, in particular for industrial, tertiary and/or residential buildings, which is equipped with a filtration and treatment assembly such as described above.

Advantageously, such an apparatus comprises at least, from upstream to downstream, a pre-filter, a treatment unit and a fan, while the filtration and treatment assembly is located downstream of that unit and upstream or downstream of the fan. This permits control, by means of the treatment unit, of the efficiency of the photocatalysis which is influenced by the temperature and humidity of the air coming into contact with the filtration medium. However, the filtration assembly may also be installed in another part of an air-conditioning apparatus that does not necessarily comprise a pre-filter or a fan.

The invention will be better understood and other advantages thereof will emerge more clearly in the light of the following description of an embodiment of an air-conditioning apparatus according to the principle thereof, equipped with a filtration and treatment assembly according to the principle thereof, which is given purely by way of example and with reference to the appended drawings in which:

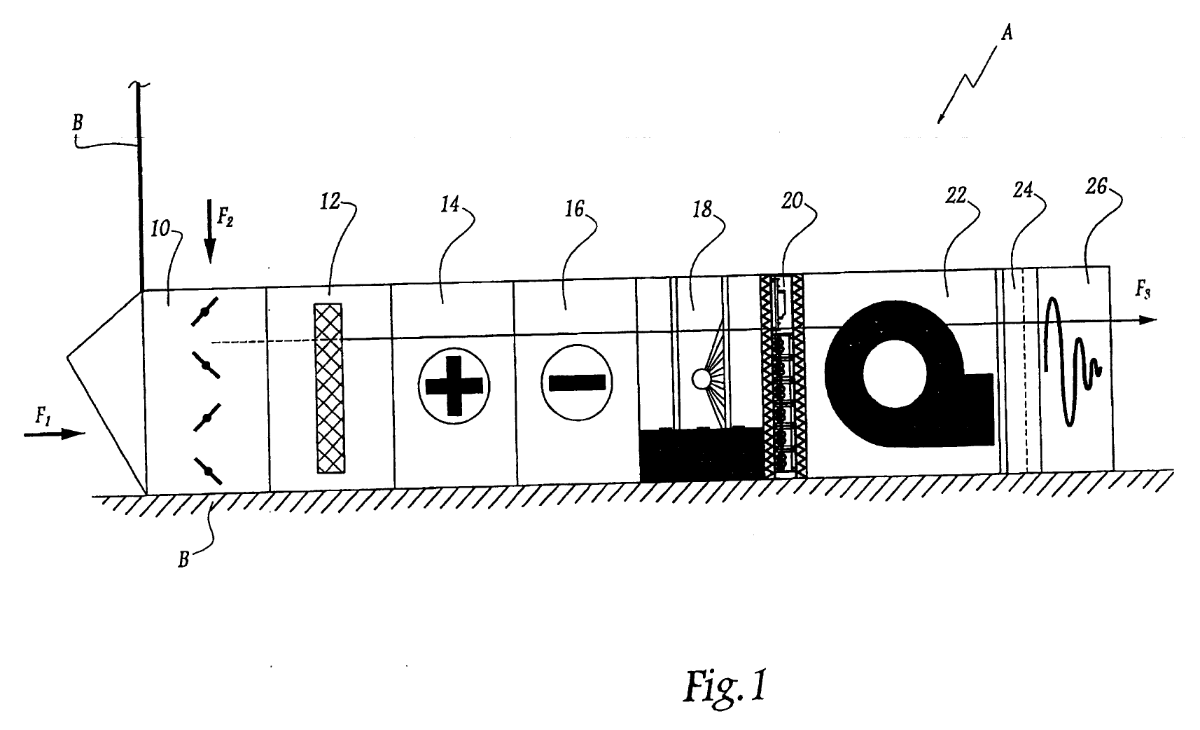

FIG. 1 is a schematic longitudinal section through an air-conditioning apparatus according to the invention;

FIG. 2 is an exploded side view of the filtration and treatment assembly with which the apparatus of FIG. 1 is equipped;

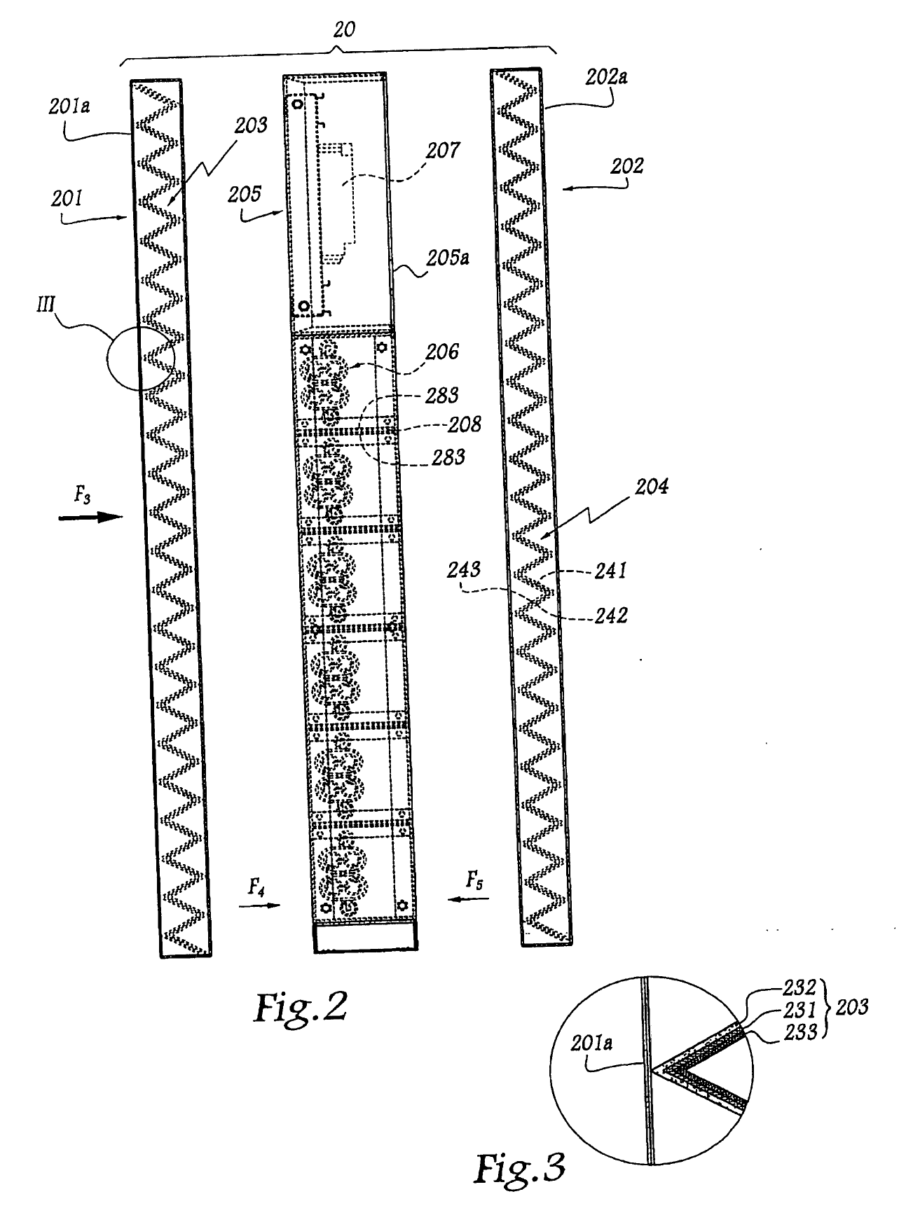

FIG. 3 is a section on a larger scale through the detail III in FIG. 2; and

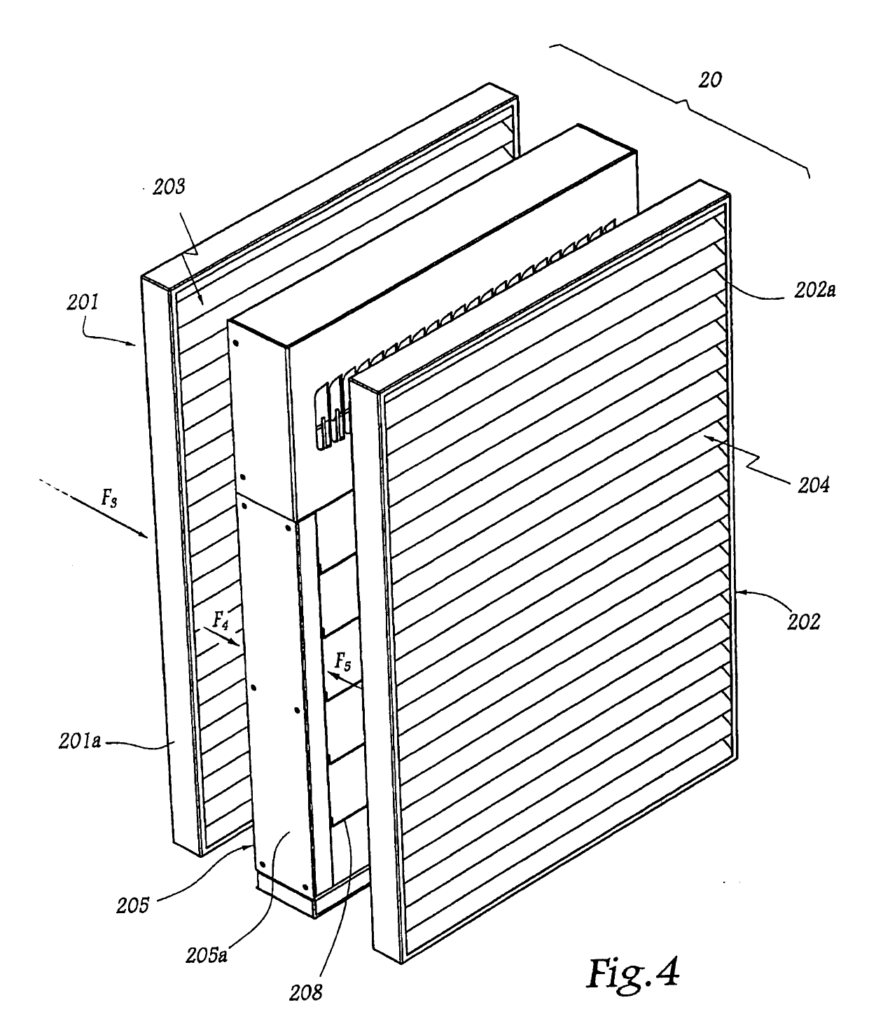

FIG. 4 is an exploded perspective view of the assembly of FIG. 2.

The apparatus A represented in FIG. 1 is provided in order to draw in air both on the outside and on the inside of a building B. In order to do this, the apparatus A is equipped with a pre-mixing chamber 10 which can be supplied with air from the outside, as represented by the arrow F₁, and from the inside of the building B, as represented by the arrow F₂.

A pre-filter 12 which is to retain the coarsest impurities is located downstream of the chamber 10.

A pre-heater battery 14, a cooling battery 16 and a humidifier 18 are located in succession downstream of the pre-filter 12 and on the path of flow of the air in the apparatus A, this flow being represented by the arrow F₃. The elements 14 to 18 constitute treatment units enabling certain physical properties of the air passing through the apparatus A to be modified.

A filter 20 enabling the air passing through the apparatus A to be treated is located downstream of the humidifier 18 and upstream of a fan 22 whose outlet is connected to a finisher filter 24 downstream of which a sound trap 26 is located.

The structure of the filter 20 emerges more particularly from FIGS. 2 to 4. This filter comprises two filtration modules 201 and 202 inside which is located a strip of filtration medium 203, 204, respectively.

The filtration medium 203 located in the upstream filtration module 201 is pleated or folded in “zigzags” inside the frame 201a of that module and comprises a permeable support 231 whose upstream side is covered with a layer 232 of activated carbon and whose downstream side is covered with a layer 233 of TiO₂. Other catalytic agents could of course be used within the scope of the present invention, such as, in particular, other metal oxides, alkaline-earth oxides, actinide oxides or rare earth oxides.

Likewise, adsorptions agents other than activated carbon may be used, such as, in particular, zeolites or polymer resins.

The filtration medium may, but not necessarily, be in accordance with the technical teaching of FR-A-2 812 825.

The filtration medium 204 located in the frame 202a of the downstream filtration module 202 is composed of the same material as the medium 203, with a permeable support 241, a layer 242 of activated carbon and a layer 243 of TiO₂. The layer 242 is located on the downstream side of the support 241 while the layer 243 is located on its upstream side.

An illumination module 205 is interposed between the modules 201 and 202 and comprises a frame 205a which contains ultra-violet lamps 206 operating at constant power in order to optimize the service life of the system. These lamps are supplied with current from one or more chokes 207 located in the frame 205a. They are separated from each other by separating plates 208 whose upper and lower faces are covered with layers 283 of TiO₂. Other photocatalytic agents may be used here. In practice, they are the same as those used in the filtration medium.

It will be appreciated that the separating plates 208 are optional, their function being to optimize the phenomenon of photocatalysis in gaseous phase.

The stream of air passes in succession through the modules 201, 205 and 202 which together form the duct for the flow of the stream of air F₃ in the assembly 20. In particular, the associated modules 201, 205 and 202, which form the structure of the assembly 20, do not have to be installed in a duct which is difficult of access.

The association of the activated carbon and the photocatalytic agent enables the stream of air F₃ to be purified by physical adsorption of the organic compounds at the activated carbon and by photocatalysis at the layers of TiO₂, the heterogeneous photocatalytic process used being broken down into five stages which are the transfer of the gaseous reagents to the photocatalytic surface, the adsorption of the gaseous reagents on that surface, the photochemical reaction between the adsorbed gaseous reagents and the mineralization of the organic compounds, the desorption of the gaseous products of the photocatalytic reduction and the transfer of the gaseous products out of the photocatalytic surface. The energy provided by the ultra-violet radiation coming from the lamps 206 enables an electron from the layer of TiO₂ to pass from the valence band to the conduction band of that material, which creates an oxidation site (hole h⁺) in the valence band and a reduction site (electron e⁻) in the conduction band. The holes h⁺ react with the electron donors which are constituted by the organic products to be adsorbed on the surface of the TiO₂. At the same time, the electrons e⁻ react with the electron acceptors.

Thus, the electron of the conduction band can be trapped by the molecular oxygen O₂ while the hole in the valence band is trapped by the basic surface hydroxyl groups or by the adsorbed water, which permits the formation of hydroxyl radicals. An oxidoreduction system and the formation of radicals or ion radicals are thus obtained. The latter are converted, react with each other or attack the organic compounds adsorbed by the TiO₂, which are thus degraded.

At the production of the assembly 20, the elements 201, 202 and 205 are joined together to form the assembly 20 and permit the efficient filtration of a quantity of air moving at a relatively fast frontal speed, greater than 2 m/s, and with a relatively great throughput.

It will be appreciated that it is possible to pre-assemble filtration modules of the same type as the module 201 or the module 202 with filtration media of different types, for example, in accordance with the nature of the activated carbon used, which is in powder form or fibre form, or in accordance with the geometry of the media 203 and 204, in particular in accordance with the preferred type of folding.

It is also possible to pre-assemble illumination modules 205 comprising pre-selected types of lamp 206.

It is therefore possible to put together an assembly 20 as a function of the use intended for the apparatus A in which it is to be integrated or as a function of the type and/or dimensions of that apparatus. In particular, the modules 201 and 202 may be selected, from several types of module, as a function of the type of particle to be treated and/or as a function of the technical-economic ratio sought.

Assembly is effected by bringing together the modules 201, 202 and 205, as represented by the arrows F₄ and F₅, then by securing those modules to each other by any suitable means, for example by screws.

The assembly 20 is particularly simple to produce but also to use because it is not necessary to employ a system of regulation, taking into account the imminence of the breakthrough point, as in some known systems.

The modules 201, 202 and 205 are preferably assembled in a reversible manner, which enables them to be separated in order to gain access to the lamps 206, in particular during maintenance operations.

The structure of the assembly 20 also enables its operating conditions to be optimized, it being possible for the temperature of the air passing through the assembly 20 to be from 10 to 60° C., while its relative humidity may be from 15% to 95%.

In particular, the organic compounds of the stream of air F₃ are adsorbed by the activated carbon of the layer 232. Permanent desorption is observed between the layers 232 and 233. The organic compounds that are not converted at the medium 203, and the intermediate compounds resulting from partial oxido-reduction at that medium, are then treated at the medium 204.

The assembly 20 renders possible the complete destruction of the organic pollutants of a flow of air by their mineralization.

In particular, the invention permits the treatment of a stream of air containing volatile organic compounds (VOCs) or semi-volatile organic compounds, perchloroethylene, 2-butene, anisoles, phenols, ozone, chloramines, lindanes and/or mixtures of those products. The invention also permits treatment of a stream of air containing compounds generating odours, such as mercaptans or cigarette smoke. The invention also permits treatment of a stream of air containing potentially pathogenic living microorganisms, such as bacteria, for example Legionella pneumophila or staphylococci, or viruses, such as the SARS virus.

According to a variant of the invention which has not been shown, the apparatus A may be designed in such a manner that the filter 20 is downstream of the fan 22.

The invention has been presented with a unitary assembly 20. It can, however, be applied with an assembly formed by dissociated elements.

1. An assembly for filtering and treating organic compounds for an air-conditioning apparatus, comprising at least one filtration medium, wherein:
the filtration medium (203, 204) comprises an adsorption agent (232, 242) and a photocatalytic agent (233, 243);
the filtration medium is distributed in two filtration modules (201, 202) through which the stream of air (F3) to be filtered and treated is to pass in succession and
illumination means (206) for the photocatalytic agent are interposed between the filtration modules (201, 202),
characterized in that the illumination means (206) are located in a module (205) through which the stream (F3) of air to be filtered passes and which constitutes, with the filtration modules (201, 202), the filtration assembly (20).

2. An assembly according to claim 1, characterized in that the adsorption agent (232, 242) and the photocatalytic agent (233, 243) are distributed, respectively, over one or, respectively, both sides of a permeable support (231, 241).

3. An assembly according to claim 1, characterized in that the adsorption agent (232, 242) is distributed over the upstream side of the filtration medium (203) located in the upstream filtration module (201) and over the downstream side of the filtration medium (204) located in the downstream filtration module (202), while the photocatalytic agent (233, 243) is distributed over the downstream side of the filtration medium (203) located in the upstream filtration module (201) and over the upstream side of the filtration medium (204) located in the downstream filtration module (202).

4. An assembly according to claim 1, characterized in that the modules (201, 202, 205) are fitted together in a reversible manner.

5. An assembly according to claim 1, characterized in that the illumination module (205) incorporates ultra-violet lamps (206) and optionally devices (207) for supplying power to said lamps.

6. An assembly according to claim 1, characterized in that the illumination module (205) is provided with at least one plate (208) which separates two adjacent lamps (206) and which is covered, on at least one of its faces, with photocatalytic agent (283).

7. An assembly according to claim 1, characterized in that the filtration medium (203, 204) is pleated in the filtration modules (201, 202).

8. A method for the production of an assembly according to claim 1, characterized in that it comprises steps consisting in:
selecting the frames (201a, 202a, 205a) of the modules (201, 202, 205) as a function of the dimensions of the air-conditioning apparatus (A) to be equipped;
selecting the filtration medium (203, 204) as a function of the type of particle to be treated;
selecting the type, the number and the power of the lamps (26) of the illumination module (205) and
interposing the illumination module (205) between the filtration modules (201, 202).

9. A method according to claim 8, characterized in that it also comprises a step which consists in assembling (F4, F5) the modules (201, 202, 205) to form a unitary assembly (20) ready to be integrated in the apparatus (A).

10. An air-conditioning apparatus (A), especially for buildings, which is equipped with a filtration and treatment assembly (20) according to claim 1.

11. An apparatus according to claim 10, comprising at least, from upstream to downstream, a pre-filter (12), a treatment unit (14-18) and a fan (22), characterized in that the filtration and treatment assembly (20) is located downstream of said unit and upstream or downstream of the fan (22).
